(19) United States
(12) Patent Application Publication
(10) Pub. No.: US 2025/0274467 A1
(43) Pub. Date: Aug. 28, 2025

(54) Electronic Devices and Corresponding Methods Electronically Prompting Fraud Warnings as a Combined Function of Impersonation Likelihood and Security Risk

(71) Applicant: Motorola Mobility LLC, Chicago, IL (US)

(72) Inventors: Thiago Francisco Martins, Indaiatuba (BR); Benicio Pereira Goulart, Campinas (BR); Leticia Mayumi Araujo Tateishi, Campinas (BR)

(21) Appl. No.: 18/590,660

(22) Filed: Feb. 28, 2024

(51) Int. Cl. H04L 9/40

(52) U.S. Cl. CPC H04L 63/1425; H04L 63/08; H04L 63/1416

(57) ABSTRACT

An electronic device includes a communication device, a user interface, and one or more processors operable with the communication device and the user interface. In response to the communication device receiving electronic signals defining an electronic communication comprising a request for benefit for a person known to an authorized user of the electronic device, the one or more processors, in parallel operations, determine both how likely the electronic communication originated from the person known to the authorized user of the authorized user of the electronic device and how likely the electronic communication is to be fraudulent. When the electronic communication is sufficiently likely to be both from a person unknown to the authorized user of the electronic device and sufficiently likely to be fraudulent, the one or more processors cause the user interface to deliver a prompt comprising a fraud warning indicating that the electronic communication is likely fraudulent.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps in either the financial applications of the device or user behavior to commit crimes and steal money. It would be advantageous to have improved devices and systems to prevent situations such as this from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates another explanatory method in accordance with one or more embodiments of the disclosure.

FIG. 4 illustrates one or more impersonation likelihood factors in accordance with one or more embodiments of the disclosure.

FIG. 5 illustrates one or more security risk factors in accordance with one or more embodiments of the disclosure.

FIG. 6 illustrates one or more method steps in accordance with one or more embodiments of the disclosure.

FIG. 7 illustrates one or more embodiments of the disclosure.

FIG. 8 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by a communication device of an electronic device from a remote electronic device across a network, electronic signals defining an electronic communication comprising an indication that the same originates from a person known to an authorized user of the electronic device, performing, in parallel, a first operation determining an impersonation likelihood score from stylistic characteristics of the electronic communication and a second operation determining a security risk score from content contained in the electronic communication, and presenting a prompt comprising a fraud warning when the impersonation likelihood score and the security risk score both exceed a threshold. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to an electronic communication comprising a request for benefit for a person known to an authorized user of the electronic device, in parallel operations determining both how likely the electronic communication originated from the person known to the authorized user of the electronic device and hoe likely the electronic communication is to be fraudulent, and presenting a prompt comprising a fraud warning when the electronic communication is sufficiently likely to be both from a person unknown to the authorized user of the electronic device and sufficiently likely to be fraudulent, as described herein. The non-processor circuits may include, but are not limited to, a radio receiver, a radio transmitter, signal drivers, clock circuits, power source circuits, and user input devices. As such, these functions may be interpreted as steps of a method to perform receiving an electronic communication from a remote electronic device requesting initiation of an electronic financial transaction from the electronic device to the remote electronic device, performing, by one or more processors, two parallel processes to determine a likelihood of impersonation and a security risk, and causing a user interface of the electronic device to present a prompt indicating that the electronic communication is likely fraudulent when a first process analyzing stylistic characteristics of the electronic communication and a second process analyzing content of the electronic communication both indicate a preponderant likelihood of impersonation and security risk.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that messaging applications have become incredibly popular. Such messaging applications have a range of users who use these applications to communicate with others across the globe. With today's technology, anyone with a smartphone can initiate electronic communication with any other person, anywhere in the world, quite easily. While this is incredibly convenient, embodiments of the disclosure also contemplate that this ease of communication presents opportunities for thieves and scammers.

Embodiments of the disclosure contemplate that one such scamming method that can be used is that of the “impersonation attack.” When an impersonation attack is implemented, a thief or scammer pretends to be someone close to the victim and sends an electronic communication asking to gain benefits. In many cases, the victim may believe that the thief is actually someone they know since such scammers often steal a profile picture and name of the known person from social media. Such thieves and scammers are also quite good at including convincing language laden with good excuses enticing the victim to transfer money or other benefits. Illustrating by example, a thief or scammer may allege that their phone was lost or that their number was changed to distract the victim from the fact that an unknown incoming number has been identified.

Once the thief or scammer convinces the victim that they are someone they are not, they frequently request a benefit such as the victim paying a bill, the victim transferring money, the victim shopping for the scammer, and so forth. Indeed, such methods have been used in Brazil to target elderly people who are not technically savvy.

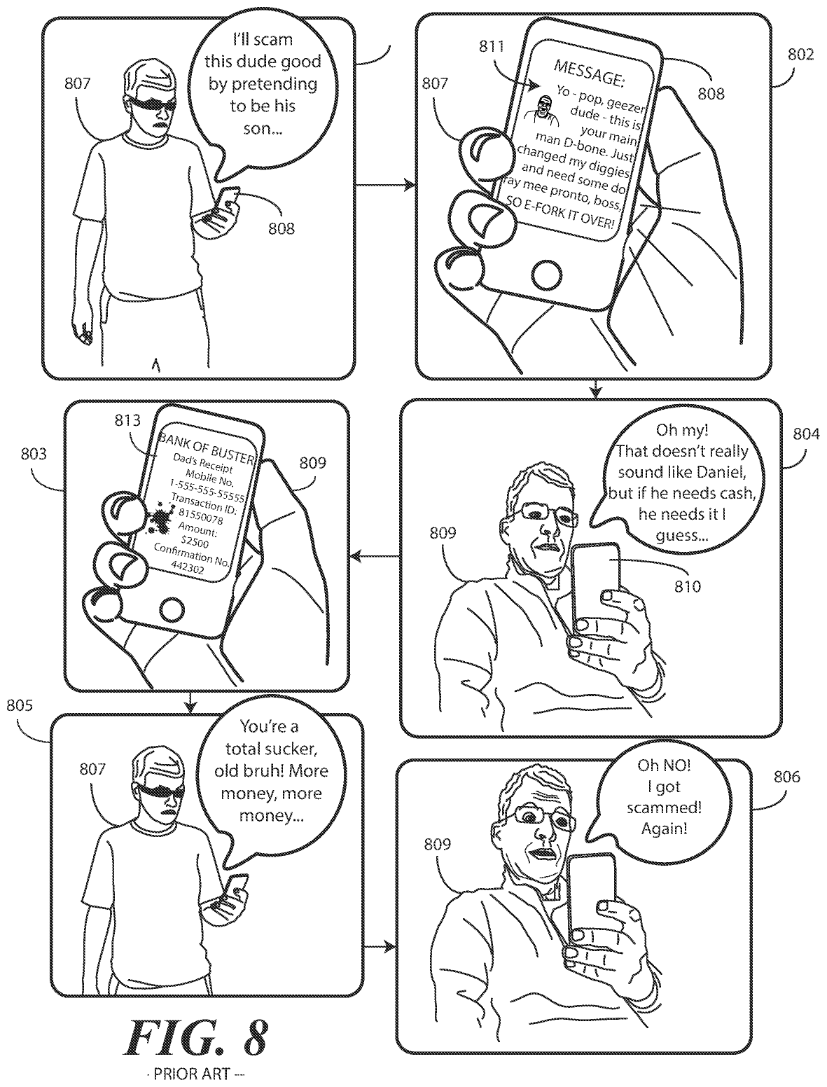

To see how such scams can operate, turn now to FIG. 8. Beginning at step 801, a scammer 807 has an electronic device 808, which is a smartphone in this illustrative example, and plans to try the old “impersonation attack” scam to dupe a target 809 out of some money. The scammer 807 knows that the victim usually communicates with his son, Daniel, using text messages. What the scammer 807 does not know is that Daniel always communicates in a formal way without using abbreviations or slang language. The scammer 807, being a ruffian, does not communicate in this manner.

At step 802, the scammer 807 composes an electronic communication 811 that will be sent using electronic signals from a communication device of the electronic device 808 to the electronic device 810 of the victim. Since the scammer 807 is unable to communicate using proper English, the electronic communication 811 says, “Yo—pop—geezer dude—is your man D-bone.” In this sentence, “D-bone” is slang for Daniel, and is thus an indication that the electronic communication 811 originates from a person known to the target 809.

The electronic communication 811 continues, as the scammer 807 attempts to justify why the number appearing on the electronic device 810 of the target 809 is not that normally associated with Daniel by saying, “Just changed my ‘diggies’ (short for ‘digits’ or phone number) and need some ‘do ray mee’ (short for cash or money) pronto, boss, so E-FORK IT OVER!” As can be seen, the scammer 807 is impersonating Daniel in a very information way with an attempt to explain that he is changed his number and needs money.

Sadly, at step 804 the target 809 is unable to discern that the electronic communication 811 originated from the scammer 807, and not Daniel. Quite concerned his son may be under duress, and being a good and decent person, the target 809 decides that cash should be transferred. Sadly, this happens all too often using prior art systems. At step 803, the target 809 initiates a financial transaction from the Bank of Buster to send twenty-five hundred US dollars to the electronic device 808 of the scammer 807.

At step 805, the scammer 807 is thrilled that the scam has been successful. Laughing fiendishly, the scammer 807 says, “You're a total sucker, old Bruh!” Paraphrasing the iconic Marc Springer of Snortn′ Boar Transport, the fraudster starts saying, “More money, more money, more money!” As shown at step 806, the poor target 809 now understands he has been scammed. Downtrodden and depressed, he laments all the work that must be done to try and get his precious money back, if that is even possible at all.

Sadly, situations such as this are all too common. Fortunately, embodiments of the disclosure provide a solution to these problems. In one or more embodiments, a solution to this problem comprises a dedicated pipeline to identify possible scams based upon electronic communications, especially electronic communications configured as text messages.

In one or more embodiments, the pipeline includes two different operations that occur in parallel. In a first operation, a computational model identifies typing and/or writing patters of contacts of interest stored in a contacts list. In one or more embodiments, this first operation analyzes typing and/or writing patterns to analyze semantic and grammatic correctness, the usage of slang, the usage of abbreviations, and determines words are sentences that are frequently used.

In a second, parallel operation, the pipeline analyzes the content of the electronic communication to understand the likelihood that a scam is occurring. The second operation may, for example, refer to kidnapping, money requests, credit card information, requests for purchases of goods, and so forth to determine whether a scam is likely occurring.

A second stage of the pipeline then determines whether the first operation and the second operation meet certain thresholds. If so, one or more processors of an electronic device can present a prompt on the user interface of the electronic device indicating that the electronic communication is likely fraudulent.

Illustrating by example, in one or more embodiments a method in an electronic device comprises receiving, by a communication device from a remote electronic device across a network, electronic signals defining an electronic communication comprising an indication that the electronic communication originates from a person known to an authorized user of the electronic device. In one or more embodiments, in response to receiving the electronic signals, one or more processors of the electronic device perform two parallel operations.

In one or more embodiments, the two parallel operations comprise a first operation and a second operation. In one or more embodiments, the first operation determines an impersonation likelihood score from stylistic characteristics contained in the electronic communication. In one or more embodiments, the second operation determines a security risk score from content contained in the electronic communication.

In one or more embodiments, when both the impersonation likelihood score exceeds an impersonation likelihood score threshold and the security risk score exceeds a security risk score threshold, one or more processors of the electronic device present, on a user interface of the electronic device, a prompt comprising a fraud warning indicating the electronic communication defined by the electronic signals is likely fraudulent.

In one or more embodiments, the first operation determines the impersonation likelihood score as a function of whether slang language appears in the electronic communication, whether grammar appears correctly in the electronic communication, whether abbreviations appear in the electronic communication, and/or whether language appearing in the electronic communication sufficiently corresponds to other language from prior electronic communications originating from the person from whom the electronic communication alleges to be sent. In one or more embodiments, this can be performed by a generative artificial intelligence engine. In one or more embodiments, the second operation determines the security risk score as a function of whether the electronic communication comprises indicia of kidnapping, a request for initiation of a financial transaction across a network, whether a device identifier fails to correspond with any device identifier stored within a contacts application operating on one or more processors of the target's device, or other factors.

In one or more embodiments, an electronic device configured in accordance with embodiments of the disclosure comprises a communication device, a user interface, and one or more processors operable with the communication device and the user interface. In one or more embodiments, in response to the communication device receiving electronic signals defining an electronic communication comprising a request for benefit for a person known to the authorized user of the electronic device, the one or more processors, in parallel operations, determine both how likely the electronic communication originated from the person known to the authorized user of the electronic device and how likely the electronic communication is to be fraudulent.

In one or more embodiments, when the electronic communication is sufficiently likely to be both from a person unknown to the authorized user of the electronic device and is sufficiently likely to be fraudulent, the one or more processors cause the user interface of the electronic device to deliver a prompt comprising a fraud warning indicating that the electronic communication is likely to be fraudulent. In one or more embodiments, the prompt comprises an audible prompt.

In one or more embodiments, a method in an electronic device comprises receiving, with a communication device, electronic signals from a remote electronic device across a network defining an electronic communication requesting initiating a financial transaction from the electronic device to the remote electronic device. In one or more embodiments, the method comprises performing, by one or more processors of the electronic device, two parallel processes to determine the likelihood of impersonation and security risk.

In one or more embodiments, the two parallel processes comprise a first process analyzing stylistic characteristics of the electronic communication to determine the likelihood of impersonation and a second process analyzing content of the electronic communication to determine the security risk. In one or more embodiments, when the first process identifies a preponderant likelihood of impersonation and the second process indicates a preponderant security risk, the one or more processors cause the user interface to present a prompt indicating the electronic device is likely fraudulent. In one or more embodiments, the prompt comprises a user actuation target precluding subsequent electronic communications from being presented at the user interface of the electronic device.

Advantageously, embodiments of the disclosure provide a robust scam detection mechanism by analyzing typing and writing patterns (in terms of semantic and grammatical correctness), possibly using generative artificial intelligence, combined with message content analysis. Other benefits will be described below. Still others will be obvious to those of ordinary skill in the art having the benefit of this disclosure.

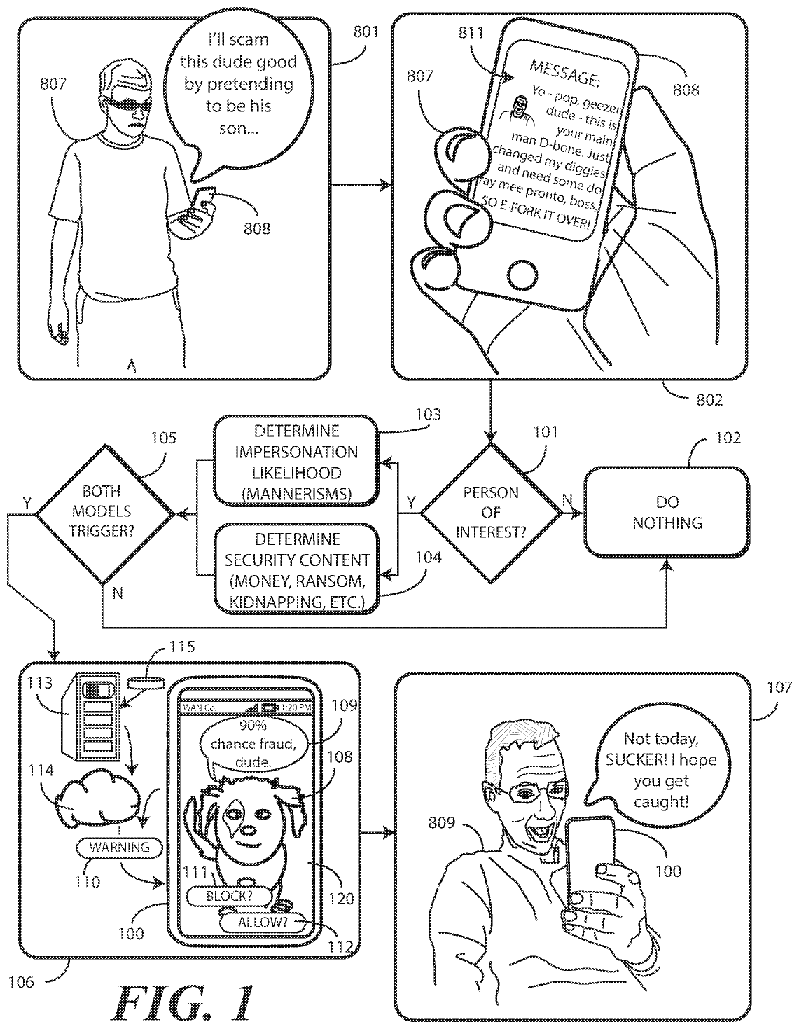

To see how embodiments of the disclosure can work beautifully, seamlessly, and smoothly prevent impersonation and other scams from occurring, turn now to FIG. 1. Once again, at step 801 our nefarious scammer 807 has an electronic device 808 and plans to again try the “impersonation attack” scam to dupe a target 809 out of some money. Knowing that the target 809 usually communicates with his son, Daniel, using text messages, at step 802 the scammer 807 again composes an electronic communication 811 that will be sent using electronic signals of the electronic device 808 to the electronic device 100 of the target 809.

Since the electronic device 100 is configured in accordance with embodiments of the disclosure, when a communication device receives the electronic communication 811 from the electronic device 808 belonging to the scammer 807, decision 101 determines whether the electronic communication 811 originates from a person known to an authorized user of the electronic device 100, which in this case is the victim. In one or more embodiments, this decision 101 comprises determining whether a device identifier of the electronic device 808 from which the electronic communication 811 is received corresponds, or fails to correspond, with any device identifier stored within a contacts application operating on the one or more processors of the electronic device 100 of the target 809. In other embodiments, this decision 101 comprises determining whether a sender name of the electronic communication 811 is received corresponds, or fails to correspond, with any contact name stored within a contacts application operating on the one or more processors of the electronic device 100 of the target 809. Other techniques for performing decision 101 will be obvious to those of ordinary skill in the art having the benefit of this disclosure.

If decision 101 determines there is no indication that the electronic communication 811 originates from a person known to an authorized user of the electronic device 100, or if decision 101 determines that the electronic communication 811 fails to originate from a person known to an authorized user of the electronic device, step 102 does nothing and allows the electronic communication 811. Otherwise, the method moves to step 103 and step 104, which comprise parallel operations.

At step 103, a first operation determines an impersonation likelihood score from stylistic characteristics contained in the electronic communication 811. This determination can be made in a variety of ways.

In one or more embodiments, the first operation occurring at step 103 determines the impersonation likelihood score as a function of whether grammar appears correctly in the electronic communication 811. Here, there is clearly poor grammar as the scammer 807 calls money “do ray mee.” Thus, in this illustrative example this determination made at step 103 would increase the impersonation likelihood score in this case.

In one or more embodiments, the first operation occurring at step 103 determines the impersonation likelihood score as a function of whether slang language appears in the electronic communication 811. In this illustrative example, lots of slang language appears in the electronic communication 811. Examples include calling an old person a “geezer” and a phone number “diggies.” Thus, in this illustrative example this determination made at step 103 would increase the impersonation likelihood score in this case.

In one or more embodiments, the first operation occurring at step 103 determines the impersonation likelihood score as a function of whether abbreviations appear in the electronic communication 811. In this illustrative example, one does, as the scammer 807 abbreviates Daniel with “D-bone.” Thus, in this illustrative example this determination made at step 103 would increase the impersonation likelihood score in this case.

In one or more embodiments, the first operation occurring at step 103 determines the impersonation likelihood score as a function of whether language appearing in the electronic communication 811 sufficiently corresponds to other language from prior electronic communications originating from the person known to an authorized user of the electronic device. Recall from above that Daniel communicates in a very formal manner. By contrast, the scammer 807 does not. Thus, in this illustrative example this determination made at step 103 would increase the impersonation likelihood score in this case. As noted above, in one or more embodiments the first operation occurring at step 103 can be performed by, or with assistance from, a generative artificial intelligence engine.

At step 104, in parallel with step 103, a second operation determines a security risk score from content contained in the electronic communication 811. As with the first operation of step 103, the second operation of step 104 can be performed in a variety of ways.

In one or more embodiments, the second operation performed at step 104 determines the security risk score as a function of whether the electronic communication 811 comprises indicia of kidnapping. If, for example, the scammer 807 had said, “I just kidnapped Daniel-pay ransom, geezer dude,” this would cause step 104 to increase the security risk score. In the illustrative example of FIG. 1, there are no such indicia, so this factor does not increase the security risk score. In other embodiments, the second operation performed at step 104 can similarly determine the security risk score as a function of whether the electronic communication 811 comprises indicia of a ransom request.

In one or more embodiments, the second operation performed at step 104 determines the security risk score as a function of whether the electronic communication 811 comprises a request for initiation of a financial transaction across the network. Here, the electronic communication 811 does, asking the target 809 to “E-FORK IT OVER!” Thus, in this illustrative example this determination made at step 104 would increase the security risk score.

In one or more embodiments, the second operation performed at step 104 determines the security risk score as a function of whether the electronic communication 811 comprises a device identifier that fails to correspond to any other device identifier stored within a contacts application operating on the one or more processors of the electronic device 100 receiving the electronic communication 811. In this case, it does, as the scammer 807 has to explain why his “diggies” would not be recognized. Thus, in this illustrative example this determination made at step 104 would increase the security risk score.

Decision 105 determines whether both the impersonation likelihood score exceeds an impersonation likelihood score threshold and the security risk score exceeds a security risk score threshold. If they both do, the method proceeds to step 106. Otherwise, the method moves to step 102.

In this illustrative example, both the impersonation likelihood score exceeds the impersonation likelihood score threshold and the security risk score exceeds the security risk score threshold. In one or more embodiments, exceeding the impersonation likelihood score threshold and security risk score threshold only takes an impersonation likelihood score and security risk score over fifty percent. In such embodiments, there is a preponderant likelihood of impersonation and a preponderant security risk. However, in other embodiments the impersonation likelihood score threshold and security risk score threshold can be defined by a user. Thus, if a user desires one or both of the impersonation likelihood score threshold and/or security risk score threshold to be sixty percent, seventy percent, seventy-five percent, eighty percent, or another percentage, they can do so using user settings in a menu. Other impersonation likelihood score thresholds and security risk score thresholds will be obvious to those of ordinary skill in the art having the benefit of this disclosure.

In this illustrative example, both the impersonation likelihood score exceeds the impersonation likelihood score threshold and the security risk score exceeds the security risk score threshold because the electronic communication 811 includes slang, includes abbreviations, includes improper grammar, has a device identifier not recognized by the electronic device 100, and requests initiation of a financial transaction. Accordingly, the method moves to step 106.

At step 106, the one or more processors of the electronic device 100 use the user interface 120 of the electronic device 100 to present a prompt 108 comprising a fraud warning 110 indicating that the electronic communication 811 is likely fraudulent. Here, the prompt 108 includes a warning 110 of fraudulent activity.

In this illustrative example, the warning 110 includes a warning level 109 based upon the impersonation likelihood score threshold and the security risk score threshold. Here the warning level 109 indicates that there is a ninety-percent chance that the electronic communication 811 is associated with fraudulent activity since the electronic communication 811 includes slang, includes abbreviations, includes improper grammar, has a device identifier not recognized by the electronic device 100, and requests initiation of a financial transaction. This the warning level 109 indicates that there is a ninety-percent chance the electronic communication 811 originated from a scammer 807.

In one or more embodiments, the reasons for the warning level 109, namely, that the electronic communication 811 includes slang, includes abbreviations, includes improper grammar, has a device identifier not recognized by the electronic device 100, and requests initiation of a financial transaction, can be presented in the prompt 108 as well. In the illustrative embodiment of FIG. 1, this information has been omitted to simplify the prompt 108.

In one or more embodiments, step 106 comprises including a user actuation target 111 in the prompt 108 allowing any electronic financial transaction requested by the electronic communication 811 to be terminated. In one or more embodiments, when the target 809 actuates the user actuation target 111, the one or more processors of electronic device 100 preclude the performance of any electronic financial transaction requested by the electronic communication 811.

In this illustrative embodiment, the prompt 108 also includes another user actuation target 112 allowing the target 809 to override the warning 110 set forth in the prompt 108 and perform an electronic financial transaction requested by the electronic communication 811. Some embodiments of the disclosure provide this user actuation target 112 in the off chance that the target 809 is really convinced that the electronic communication 811 originated from a legitimate source.

Fortunately, here the one or more processors of electronic device 100 cause presentation of the prompt 108 before the target 809 can take any action initiating any electronic financial transaction requested by the electronic communication 811. Accordingly, the target 809 immediately actuates the user actuation target 111 provided by the prompt 108 to block any future communications from being received from the electronic device 808 belonging to the scammer 807. In one or more embodiments, actuation of this user actuation target 111 can also preclude the initiation of any electronic financial transaction requested by the electronic communication 811 as well, as noted above.

As shown at step 107, the target 809 is elated. He exclaims, “Not today, sucker! I hope you get caught.” After successfully thwarting the fraud using embodiments of the disclosure, he decides to treat himself to a delicious pot of dragonwell green tea with a few jasmine pearls added for good measure.

It should be noted that the warning 110 can be generated locally by the one or more processors of the electronic device 100 in one or more embodiments. In other embodiments, the electronic device 100 can be in communication with a cloud server 113 across a network 114. In such instances, the cloud server 113 may generate the warning after performing the analysis to determine the impersonation likelihood score and security risk score. The use of a cloud server 113 is advantageous, for example, when the determination of one or both of the impersonation likelihood score or security risk score utilizes a generative artificial intelligence engine 115.

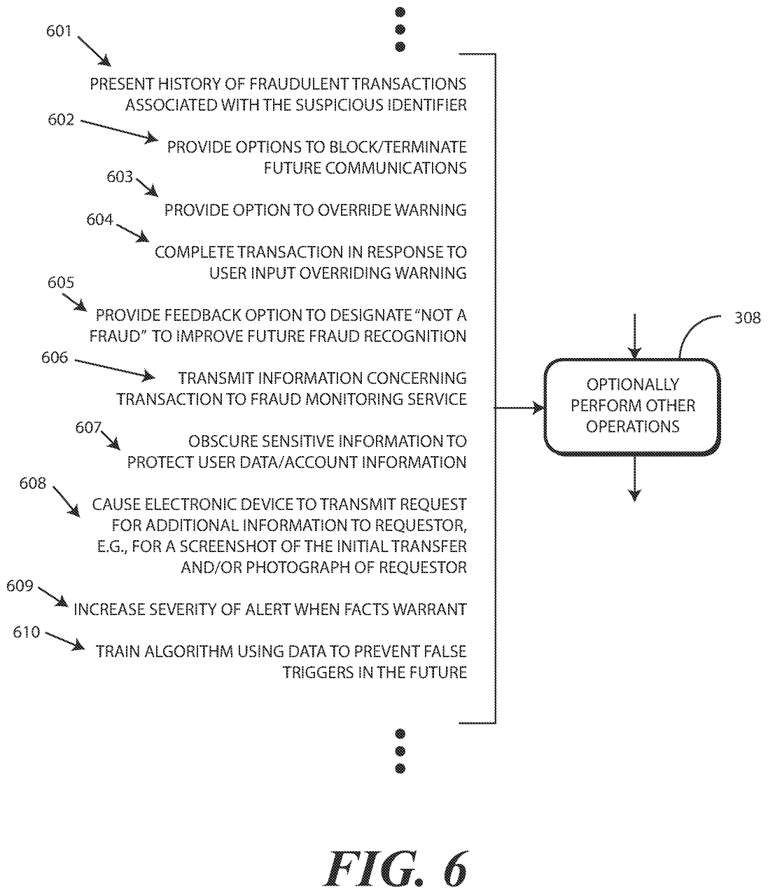

Other steps can optionally be performed in addition to the presentation of the prompt 108. Illustrating by example, optional step 106 can provide additional details about the scammer 807 and/or past fraudulent activity. Step 106 can comprise optionally presenting a history of fraudulent transactions associated with any account identified by the electronic communication 811 that is deemed to be suspicious. Other steps that can be taken will be described below with reference to FIG. 6. Still others will be obvious to those of ordinary skill in the art having the benefit of this disclosure.

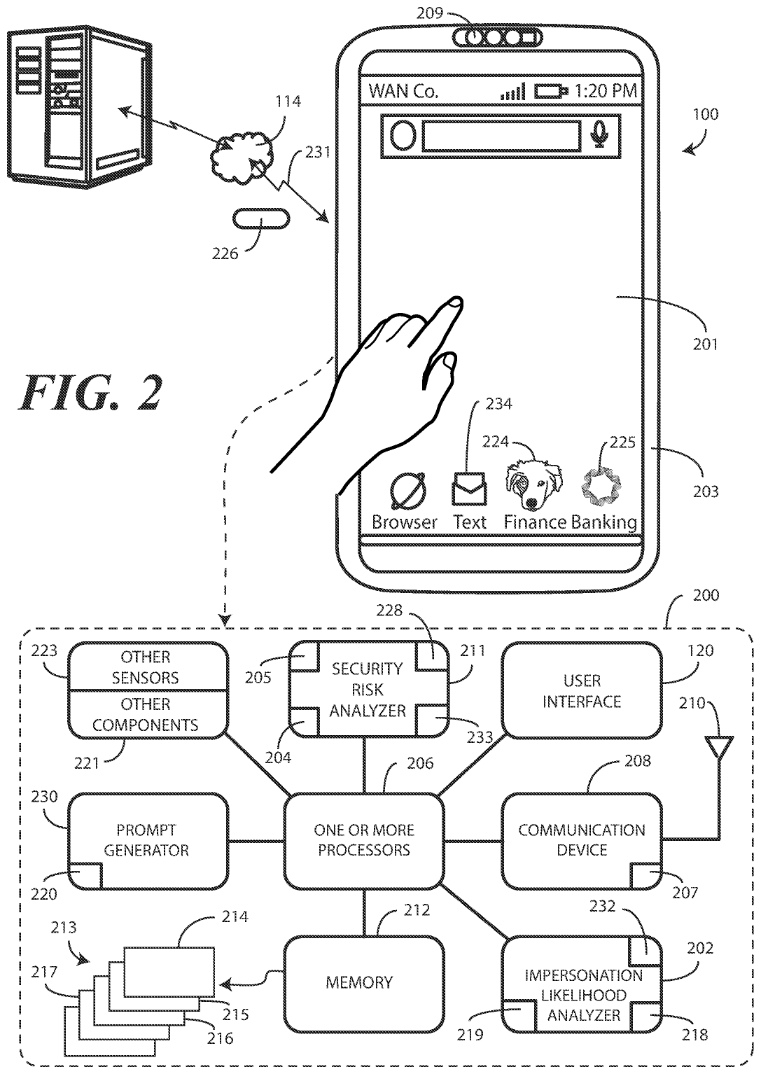

Turning now to FIG. 2, illustrated therein is one electronic device 100 configured in accordance with one or more embodiments of the disclosure. The electronic device 100 of this illustrative embodiment includes a user interface 120. In one or more embodiments, the user interface 120 comprises a display 201, which may optionally be touch-sensitive. The display 201 can serve as a primary user interface 120 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, a text messaging application 234 configured to send and receive electronic communications such as the electronic communication (811) of FIG. 1, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more financial applications 224 and/or banking applications 225 that allow financial transactions to be made using the electronic device 100.

In one or more embodiments, the electronic device comprises an impersonation likelihood analyzer 202 and a security risk analyzer 211. In one or more embodiments, in response to the communication device 208 receiving electronic signals 231 defining an electronic communication 226 comprising a request for benefit for a person known to an authorized user of the electronic device 100, the impersonation likelihood analyzer 202 and the security risk analyzer 211 work in parallel to perform operations that determine both how likely the electronic communication 226 originates from the person known to an authorized user of the electronic device 100, which is performed by the impersonation likelihood analyzer 202, and how likely the electronic communication 226 is to be fraudulent, which is determined by the security risk analyzer 211.

In one or more embodiments, when the electronic communication 226 is sufficiently likely to be both from a person unknown to the authorized user of the electronic device 100 and is sufficiently likely to be fraudulent, a prompt generator 230 cause the user interface 120 to deliver a prompt 220 comprising a fraud warning indicating that the electronic communication 226 is likely fraudulent. While the prompt (108) shown above in FIG. 1 was a visual prompt, in other embodiments the prompt 220 comprises an audible prompt.

In one or more embodiments, the prompt generator 230 only causes the user interface 120 to deliver the prompt 220 when the electronic communication 226 is received from an unknown remote electronic device, as determined by the impersonation likelihood analyzer 202. In one or more embodiments, the security risk analyzer 211 and impersonation likelihood analyzer 202 determine the electronic communication 226 is sufficiently likely to be both from the person unknown to the authorized user of the electronic device 100 and sufficiently likely to be fraudulent when it comprises an electronic financial transaction request 204 and includes both slang 218 and abbreviations 219.

In other embodiments, the security risk analyzer 211 and impersonation likelihood analyzer 202 determine the electronic communication 226 is sufficiently likely to be both from the person unknown to the authorized user of the electronic device 100 and sufficiently likely to be fraudulent when it comprises indicia of kidnapping 205 or ransom 228 and improper grammar 232. In one or more embodiments, the security risk analyzer 211 can be configured to determine that a security risk score exceeds a security risk score threshold when the electronic communication 226 includes a request for benefit 233 comprising a request to pay a bill for a sender of the electronic communication 226. In still other embodiments, the security risk analyzer 211 can determine the security risk score exceeds a security risk score threshold when the request for benefit 233 comprises a request to shop for a sender of the electronic communication 226.

In one or more embodiments, the one or more processors 206 are responsible for managing the applications and all personal information received from the user interface 120 that is to be used by the finance application 224 and/or banking application 225 after the electronic device 100 is authenticated as a secure electronic device and the user identification credentials have triggered a login event. The one or more processors 206 can also be responsible for launching, monitoring and killing the various applications and the various application service modules.

In one or more embodiments, the one or more processors 206 are operable to not only kill the applications, but also to expunge any and all personal data, data, files, settings, or other configuration tools when the electronic device 100 is reported stolen or when the finance application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 223, which may include key selection sensors, touch pad sensors, capacitive sensors, motion sensors, and switches. Similarly, the other components 221 can include video, audio, and/or mechanical outputs.

The one or more sensors 223 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the impersonation likelihood analyzer 202, the security risk analyzer 211, and the prompt generator 230 can be operable with one or more processors 206. Other embodiments, the impersonation likelihood analyzer 202, the security risk analyzer 211, and the prompt generator 230 can be configured as a component of the one or more processors 206 or configured as one or more executable code modules operating on the one or more processors 206. In other embodiments, the impersonation likelihood analyzer 202, the security risk analyzer 211, and the prompt generator 230 can be standalone hardware components operating executable code or firmware to perform their functions. Other configurations for the impersonation likelihood analyzer 202, the security risk analyzer 211, and the prompt generator 230 will be obvious to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

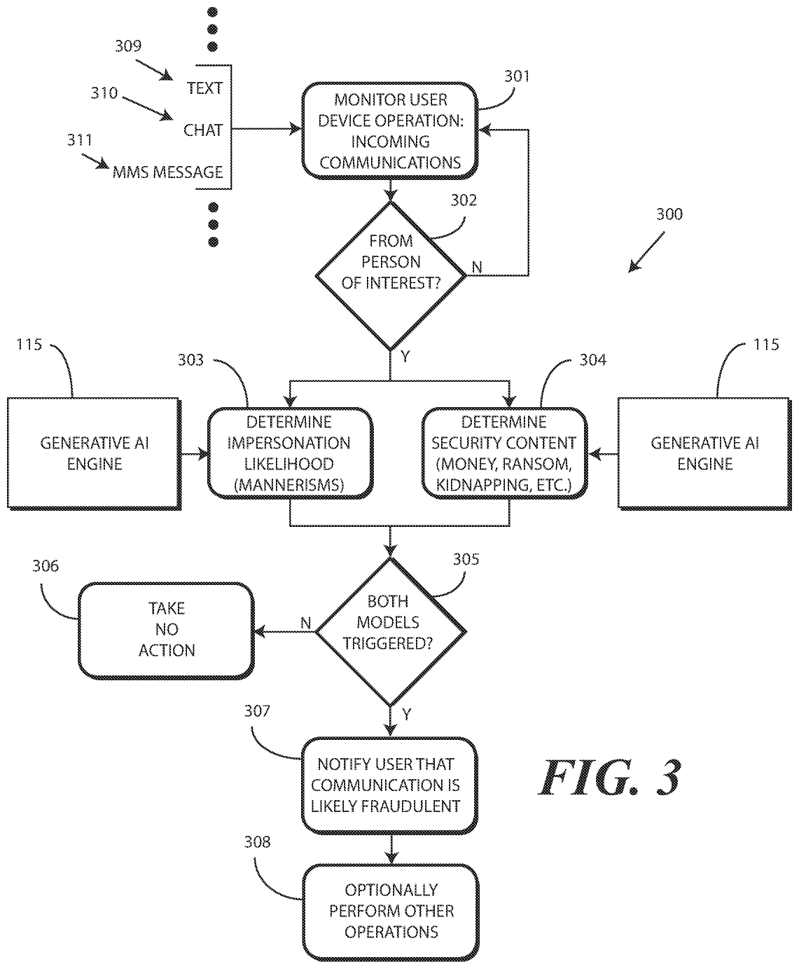

Turning now to FIG. 3, illustrated therein is one explanatory method 300 suitable for use in an electronic device, one example of which is the electronic device (100) of FIGS. 1-2. Beginning at step 301, one or more processors of the electronic device use a communication device to monitor for incoming communications. Examples of such incoming communications include text messages 309, chat messages 310, and multimedia messages 311. Other examples of potential incoming communications will be obvious to those of ordinary skill in the art having the benefit of this disclosure.

In one or more embodiments, when the communication device receives electronic signals from a remote electronic device across a network defining an electronic communication requesting initiation of an electronic financial transaction from the electronic device to the remote electronic device, decision 302 determines whether the electronic communication was sent from a person known to an authorized user of the electronic device. If it was, the method 300 returns to step 301 to continue monitoring for other incoming electronic communications.

Otherwise, i.e., when decision 302 determines that the incoming electronic communication was from a person unknown to an authorized user of the electronic device, the method 300 comprises performing, by one or more processors operable with the communication device, two parallel processes at step 303 and step 304 to determine a likelihood of impersonation and security risk, respectively. In one or more embodiments, step 303 comprises performing a first process analyzing stylistic characteristics of the electronic communication to determine the landscape image orientation. In parallel, step 304 performs a second process analyzing content of the electronic communication to determine the security risk. One or both of step 303 and step 304 can be performed using the assistance of a generative artificial intelligence engine 115.

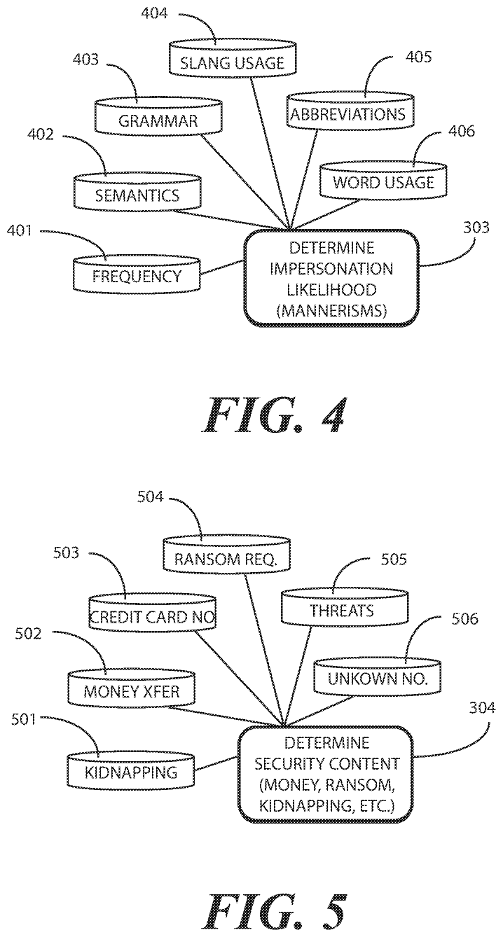

Step 303 and step 304 can be performed in a variety of ways. Turning briefly to FIG. 4, illustrated therein are stylistic characteristics of the electronic communication that step 303 can analyze to determine the likelihood of impersonation. In one or more embodiments, the first operation performed at step 303 comprises determining the likelihood of impersonation as a function of how frequently 401 electronic communications are received from the remote electronic device. If, for example, an electronic communication requesting a financial benefit for the sender of the electronic communication is the only electronic communication ever received from that remote electronic device, the electronic communication is more likely to be fraudulent than if it originates from a remote electronic device that sends non-fraudulent electronic communications ten times a day.

In other embodiments, the first operation performed at step 303 comprises determining the likelihood of impersonation by analyzing the semantics 402 of the electronic communication that was received. “Semantics” refers to the meaning set forth by the content of the electronic communication. Thus, a more demanding electronic communication is more likely to be associated with an impersonation scam than is one including a passive request. “Send money now! I mean it!” would be more likely to be associated with a likelihood of impersonation that would be “Dad, I could use some laundry money when you get a chance-no rush,” and so forth.

In one or more embodiments, the first operation performed at step 303 comprises determining the likelihood of impersonation by determining whether the grammar 403 appears correctly in the electronic communication. In still other embodiments, the first operation performed at step 303 comprises determining the likelihood of impersonation by determining whether slang language 404 appears in the electronic communication. In still other embodiments, the first operation performed at step 303 comprises determining the likelihood of impersonation as a function of whether abbreviations 405 appear in the electronic communication.

In still other embodiments, the first operation performed at step 303 can determine the likelihood of impersonation as a function of whether language 406 appearing in the electronic communication sufficiently corresponds to other language from prior electronic communications originating from persons known to an authorized user of the electronic device. If there is no overlap between the language 406 used in previous electronic communications from persons known to an authorized user of the electronic device, the electronic communication is more likely to be fraudulent, and so forth.

Turning now to FIG. 5, step 304 from FIG. 3 can determine the security risk as a function of the content of the electronic communication in one or more embodiments. Examples of such content indicating a security risk exists are shown. Other examples will be obvious to those of ordinary skill in the art having the benefit of this disclosure.

In one or more embodiments, the second operation performed at step 304 determines there is a security risk when the content of the electronic communication comprises indicia of kidnapping 501 or ransom 504 or threats 505 to the authorized user of the electronic device. Similarly, the second operation performed at step 304 can determine a security risk exists when the electronic communication comprises a request for benefit, such as the request of an initiation of an electronic financial transaction 502 or credit card numbers 503 or other financial information. Likewise, the second operation performed at step 304 can determine there is a security risk when a device identifier 506 fails to correspond with any device identifier stored within a contacts application operating on the one or more processors of the electronic device.

It should be noted that the examples of stylistic characteristics set forth in FIG. 4 used to perform the first operation of step 303 and the examples of content set forth in FIG. 5 used to perform the second operation of step 304 are illustrative only. Moreover, they can be used in any combination. What's more, other examples of stylistic characteristics set forth in FIG. 4 used to perform the first operation of step 303 and the examples of content set forth in FIG. 5 used to perform the second operation of step 304 will be obvious to those of ordinary skill in the art having the benefit of this disclosure.

Turning now back to FIG. 3, after the parallel operations defined by step 303 and step 304 are performed, decision 305 determines whether both operations indicated that there was a combined likelihood of impersonation and security risk. In one or more embodiments, decision 305 determines whether both the first process of step 303 identifies a preponderant likelihood of impersonation and the second process of step 304 determines a preponderant security risk. While a preponderant standard is one example of how decision 305 can occur, as noted above other thresholds may be defined by a user for making the determination of decision 305 as well.

Where this occurs, e.g., when both the first process of step 303 identifies a preponderant likelihood of impersonation and the second process of step 304 determines a preponderant security risk, step 307 comprises presenting a prompt indicating that the electronic communication is likely fraudulent on a user interface of the electronic device. In one or more embodiments, the prompt comprises a user actuation target precluding subsequent electronic communications from being presented at the user interface of the electronic device. Otherwise, the method 300 can take no action at step 306.

Optional step 308 can then perform other operations. Turning now to FIG. 6, illustrated therein are some examples of operations that can be performed at step 308.

These other operations can include presenting a history 601 of fraudulent transactions associated with the remote electronic device from which the electronic communication originated. As noted above, options 602 to block additional electronic communications from being received from the remote electronic device can be provided using user actuation targets or other techniques in the prompt indicating that the electronic communication is likely fraudulent.

Override options 603 can be provided to allow the prompt or fraud warning to be overridden. Illustrating by example, in one or more embodiments a user actuation target can be provided that allows an override 604 of the fraud warning. Where this is actuated, the electronic device can complete a financial transaction requested by an electronic communication or other request for benefit set forth in the electronic communication.

In one or more embodiments, the other operations can include providing a feedback mechanism 605 allowing a user who knows that an electronic communication is not fraudulent to report the same when a fraud warning is presented. This may help the electronic device or a server complex with which the electronic device is in communication better detect fraudulent activity in the future. Information 606 concerning the fraudulent activity can be transmitted to a fraud monitoring service so that if a fraudster tries to commit similar scams in the future they will be caught and put in jail.

If the electronic communication requests a reply communication from the target of a scam, one or more portions 607 of any such reply can be obscured prior to communication of the screenshot. Said differently, an operation that can be performed at step 308 comprises obscuring one or more portions 607 of any communications to a remote electronic device from which a likely fraudulent electronic communication was received prior to transmitting the reply communication.

In some embodiments, additional information 608 from the source of the electronic communication can be requested before any electronic financial transactions can be initiated by the recipient of the electronic communication. This additional information may include a picture of the person sending the electronic communication, a picture of a driver's license or other government identification of the person sending the electronic communication, or other information more particularly identifying the person sending the electronic communication.

The impersonation likelihood score threshold and/or security risk score threshold of the fraud warning in the prompt 609 can be increased or decreased based upon the facts of the situation. Of course, a backend system 610 can be trained from the facts at hand to improve future fraudulent activity warnings as well.

Other operations that can be performed at step 308 will be obvious to those of ordinary skill in the art having the benefit of this disclosure. Examples include providing more information about the fraudster, providing reasons for flagging the electronic communication as fraudulent, providing details of previous fraudulent incidents, and other information.

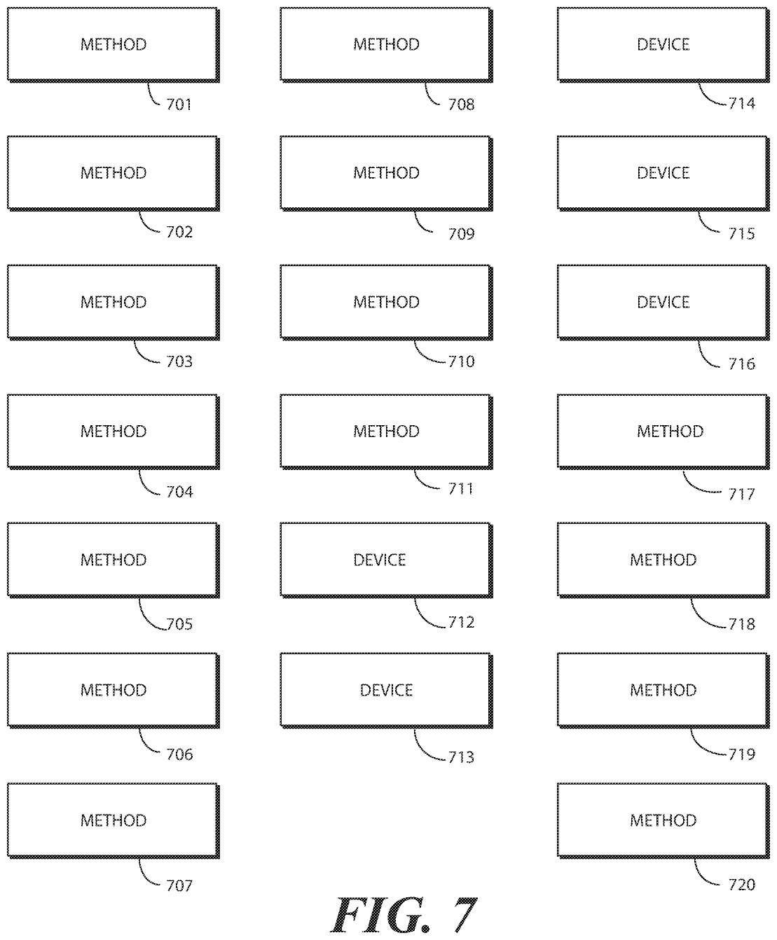

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

At 701, a method in an electronic device comprises receiving, by a communication device from a remote electronic device across a network, electronic signals defining an electronic communication comprising an indication that the electronic communication originates from a person known to an authorized user of the electronic device. At 701, in response to receiving the electronic signals, the method comprises performing, by one or more processors of the electronic device, parallel operations.

At 701, the parallel operations comprise a first operation determining an impersonation likelihood score from stylistic characteristics contained in the electronic communication and a second operation determining a security risk score from content contained in the electronic communication. At 701, when both the impersonation likelihood score exceeds an impersonation likelihood score threshold and the security risk score exceeds a security risk score threshold, the method comprises presenting, by the one or more processors on a user interface of the electronic device, a prompt comprising a fraud warning indicating that the electronic communication defined by the electronic signals is likely fraudulent.

At 702, the first operation of 701 determines the impersonation likelihood score as a function of whether slang language appears in the electronic communication defined by the electronic signals. At 703, the first operation of 701 determines the impersonation likelihood score as a function of whether grammar appears correctly in the electronic communication defined by the electronic signals.

At 704, the first operation of 701 determines the impersonation likelihood score as a function of whether abbreviations appear in the electronic communication defined by the electronic signals. At 705, the first operation of 701 determines the impersonation likelihood score as a function of whether language appearing in the electronic communication defined by the electronic signals sufficiently corresponds to other language from prior electronic communications originating from the person known to the authorized user of the electronic device. At 706, the first operation of 701 is performed by a generative artificial intelligence engine.

At 707, the second operation of 701 determines the security risk score as a function of whether the electronic communication defined by the electronic signals comprises indicia of kidnapping. At 708, the second operation of 701 determines the security risk score as a function of whether the electronic communication defined by the electronic signals comprises a request for initiation of a financial transaction across the network.

At 709, the second operation of 701 determines the security risk score as a function of whether the electronic communication defined by the electronic signals comprises indicia of a ransom request. At 710, the second operation of 701 determines the security risk score as a function of whether the electronic communication defined by the electronic signals comprises a device identifier that fails to correspond with any device identifier stored within a contacts application operating on the one or more processors of the electronic device. At 711, the prompt of 701 comprises a user actuation target allowing the authorized user to override the prompt.

At 712, an electronic device comprises a communication device, a user interface, and one or more processors operable with the communication device and the user interface. At 712, in response to the communication device receiving electronic signals defining an electronic communication comprising a request for benefit for a person known to an authorized user of the electronic device, the one or more processors, in parallel operations, determine both how likely the electronic communication originated from the person known to the authorized user of the authorized user of the electronic device and how likely the electronic communication is to be fraudulent.

At 712, when the electronic communication is sufficiently likely to be both from a person unknown to the authorized user of the electronic device and sufficiently likely to be fraudulent, the one or more processors cause the user interface to deliver a prompt comprising a fraud warning indicating that the electronic communication is likely fraudulent. At 713, the prompt of 712 comprises an audible prompt.

At 714, the one or more processors of 712 cause the user interface to deliver the prompt only when the electronic communication is received from an unknown remote electronic device. At 715, the electronic communication of 712 is sufficiently likely to be both from the person unknown to the authorized user of the electronic device and sufficiently likely to be fraudulent when it comprises an electronic financial transaction request and includes both slang and abbreviations.

At 716, the electronic communication of 712 is sufficiently likely to be both from the person unknown to the authorized user of the electronic device and sufficiently likely to be fraudulent when it comprises indicia of kidnapping or ransom and improper grammar. At 717, the request for benefit of 712 comprises a request to pay a bill for a sender of the electronic communication. At 718, the request for benefit of 712 comprises a request to shop for a sender of the electronic communication.

At 719, a method in an electronic device comprises receiving, with a communication device, electronic signals from a remote electronic device across a network defining an electronic communication requesting initiation of an electronic financial transaction from the electronic device to the remote electronic device. At 719, the method comprises performing, by one or more processors operable with the communication device, two parallel processes to determine likelihood of impersonation and security risk.

At 719, the two parallel processes comprise a first process analyzing stylistic characteristics of the electronic communication to determine the likelihood of impersonation and a second process analyzing content of the electronic communication to determine the security risk. At 719, where the first process identifies a preponderant likelihood of impersonation and the second process indicates a preponderant security risk, the one or more processors cause a user interface of the electronic device to present a prompt indicating that the electronic communication is likely fraudulent. At 720, the prompt of 719 comprises a user actuation target precluding subsequent electronic communications from being presented at the user interface of the electronic device.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Illustrating by example, while examples of stylistic characteristics and content were described above, others will be obvious to those of ordinary skill in the art having the benefit of this disclosure.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a communication device from a remote electronic device across a network, electronic signals defining an electronic communication comprising an indication that the electronic communication originates from a person known to an authorized user of the electronic device;
in response to receiving the electronic signals, performing, by one or more processors of the electronic device, parallel operations comprising:
a first operation determining an impersonation likelihood score from stylistic characteristics contained in the electronic communication; and
a second operation determining a security risk score from content contained in the electronic communication; and
when both:
the impersonation likelihood score exceeds an impersonation likelihood score threshold; and
the security risk score exceeds a security risk score threshold:
presenting, by the one or more processors on a user interface of the electronic device, a prompt comprising a fraud warning indicating that the electronic communication defined by the electronic signals is likely fraudulent.

2. The method of claim 1, wherein the first operation determines the impersonation likelihood score as a function of whether slang language appears in the electronic communication defined by the electronic signals.

3. The method of claim 1, wherein the first operation determines the impersonation likelihood score as a function of whether grammar appears correctly in the electronic communication defined by the electronic signals.

4. The method of claim 1, wherein the first operation determines the impersonation likelihood score as a function of whether abbreviations appear in the electronic communication defined by the electronic signals.

5. The method of claim 1, wherein the first operation determines the impersonation likelihood score as a function of whether language appearing in the electronic communication defined by the electronic signals sufficiently corresponds to other language from prior electronic communications originating from the person known to the authorized user of the electronic device.

6. The method of claim 1, wherein the first operation is performed by a generative artificial intelligence engine.

7. The method of claim 1, wherein the second operation determines the security risk score as a function of whether the electronic communication defined by the electronic signals comprises indicia of kidnapping.

8. The method of claim 1, wherein the second operation determines the security risk score as a function of whether the electronic communication defined by the electronic signals comprises a request for initiation of a financial transaction across the network.

9. The method of claim 1, wherein the second operation determines the security risk score as a function of whether the electronic communication defined by the electronic signals comprises indicia of a ransom request.

10. The method of claim 1, wherein the second operation determines the security risk score as a function of whether the electronic communication defined by the electronic signals comprises a device identifier that fails to correspond with any device identifier stored within a contacts application operating on the one or more processors of the electronic device.

11. The method of claim 1, wherein the prompt comprises a user actuation target allowing the authorized user to override the prompt.

12. An electronic device, comprising:
a communication device;
a user interface; and
one or more processors operable with the communication device and the user interface;
wherein, in response to the communication device receiving electronic signals defining an electronic communication comprising a request for benefit for a person known to an authorized user of the electronic device, the one or more processors, in parallel operations, determine both:
how likely the electronic communication originated from the person known to the authorized user of the authorized user of the electronic device; and
how likely the electronic communication is to be fraudulent; and
when the electronic communication is sufficiently likely to be both from a person unknown to the authorized user of the electronic device and sufficiently likely to be fraudulent, the one or more processors cause the user interface to deliver a prompt comprising a fraud warning indicating that the electronic communication is likely fraudulent.

13. The electronic device of claim 12, wherein the prompt comprises an audible prompt.

14. The electronic device of claim 12, wherein the one or more processors cause the user interface to deliver the prompt only when the electronic communication is received from an unknown remote electronic device.

15. The electronic device of claim 12, wherein the electronic communication is sufficiently likely to be both from the person unknown to the authorized user of the electronic device and sufficiently likely to be fraudulent when it comprises an electronic financial transaction request and includes both slang and abbreviations.

16. The electronic device of claim 12, wherein the electronic communication is sufficiently likely to be both from the person unknown to the authorized user of the electronic device and sufficiently likely to be fraudulent when it comprises indicia of kidnapping or ransom and improper grammar.

17. The electronic device of claim 12, wherein the request for benefit comprises a request to pay a bill for a sender of the electronic communication.

18. The electronic device of claim 12, wherein the request for benefit comprises a request to shop for a sender of the electronic communication.

19. A method in an electronic device, the method comprising:
receiving, with a communication device, electronic signals from a remote electronic device across a network defining an electronic communication requesting initiation of an electronic financial transaction from the electronic device to the remote electronic device;
performing, by one or more processors operable with the communication device, two parallel processes to determine likelihood of impersonation and security risk, the two parallel processes comprising:
a first process analyzing stylistic characteristics of the electronic communication to determine the likelihood of impersonation; and
a second process analyzing content of the electronic communication to determine the security risk; and
where the first process identifies a preponderant likelihood of impersonation and the second process indicates a preponderant security risk, the one or more processors cause a user interface of the electronic device to present a prompt indicating that the electronic communication is likely fraudulent.

20. The method of claim 19, the prompt comprising a user actuation target precluding subsequent electronic communications from being presented at the user interface of the electronic device.
